(19) United States
(12) Patent Application Publication
(10) Pub. No.: US 2026/0170546 A1
(43) Pub. Date: Jun. 18, 2026

(54) PERSONALIZED NOSE PAD RECOMMENDATION SYSTEM AND METHOD FOR CLASSIFYING A NOSE TYPE BASED ON FACIAL SCAN DATA OF A USER AND RECOMMENDING A NOSE PAD ACCORDING TO THE CLASSIFIED NOSE TYPE

(71) Applicant: Coptiq Co., Ltd., Seoul (KR)

(72) Inventors: Woo Seok SUNG, Seoul (KR); Hyung Jin PARK, Seoul (KR); Myung Gwon CHO, Seoul (KR); Jun Hyeok WON, Seogwipo-si (KR)

(73) Assignee: Coptiq Co., Ltd., Seoul (KR)

(21) Appl. No.: 19/291,810

(22) Filed: Aug. 6, 2025

Related U.S. Application Data
(60) Provisional application No. 63/734,870, filed on Dec. 17, 2024.

(51) Int. Cl. G06Q 30/0601; G06V 10/762; G06V 40/16

(52) U.S. Cl. CPC G06Q 30/0631; G06V 10/762; G06V 40/171

(57) ABSTRACT

The present invention relates to a customized nose pad recommendation system and method, which classifies a user's nose type based on facial scan data and recommends a nose pad suitable for the user according to the classified nose type. More specifically, the invention pertains to a technique for quantitatively classifying the user's nose by analyzing various facial indicator data related to nose shape, and for providing an optimal nose pad based on representative values and adjustment values corresponding to each nose type class. The invention calculates class-wise probabilities for each variable using Cumulative Distribution Function (CDF)-based relative distance computation, determines the class to which the user most likely belongs based on the highest probability, and refers to the corresponding adjustment value data to recommend a nose pad. The recommendation result can be iteratively adjusted and validated based on the Vertex Distance (VD) value.

### BACKGROUND OF THE DISCLOSURE

### Field of the Disclosure

Example embodiments relate to a personalized nose pad recommendation system and method for classifying a nose type based on facial scan data of a user and recommending a nose pad according to the classified nose type, and more particularly, to a technology for enabling customized fitting for the user by quantitatively classifying nose types through analysis of nose-related indicators and deriving optimal nose pad adjustment values based on the classification results.

### Description of the Related Art

Recently, technologies aimed at improving the wearing comfort and user satisfaction of wearable devices, particularly glasses and AR/VR devices, have been actively researched. Among these, there is a growing effort to automatically optimize the fitting of glasses based on each user’s unique facial structure.

Accordingly, technologies that analyze the user’s nasal structure quantitatively using facial scan data and customize the shape of the nose pad or glasses bridge based on the analysis have attracted attention.

Conventional technologies primarily perform simple classification based on 2D facial images or a limited number of facial metrics, or manually adjust the nosepad position based on empirical knowledge.

However, such approaches have difficulty accurately reflecting the diversity and complexity of nasal structures. In particular, even with the same nasal bridge height, the fitting result may vary depending on factors such as the angle of the nasal columella or the presence of asymmetry. Therefore, existing methods have limitations in achieving precise and automatic personalization.

Furthermore, existing methods often fail to effectively classify or handle outlier data—such as extremely high nasal bridges or deviated noses—which makes it challenging to provide optimal fitting results to users.

### SUMMARY

The present invention is directed to automatically classifying a nose type by quantitatively analyzing the shape of the nose based on facial scan data of a user.

The present invention is directed to improving wearing comfort and stability by recommending an optimized nose pad for each user according to the analyzed nose type.

The present invention is directed to deriving a plurality of nose-related variables, such as nasal bridge height and nasal columella width, and enhancing analytical accuracy by eliminating redundant or low-impact variables through correlation analysis.

The present invention is directed to classifying nose data corresponding to outliers into a separate nose type class in addition to the basic nose type classes, thereby enabling consistent recommendations for diverse user groups.

The present invention is directed to quantitatively calculating the probability that each user’s data belongs to a nose type class by using distance computation based on a cumulative distribution function (CDF), and recommending a nose pad based on the class with the highest probability.

The present invention is directed to manufacturing a nose pad corresponding to a classified nose type based on adjustment value data obtained from actual fitting results, and verifying the nose pad based on a vertex distance (VD) criterion, thereby ensuring reliable manufacturing and recommendation of nose pads.

In one embodiment of the personalized nose pad recommendation system, the system may include: a facial scanning unit configured to scan a face of a user and generate a plurality of facial metric data, a variable generation unit configured to generate analysis data including a plurality of nose-related variables describing the shape of the nose among the facial metric data, a nose type classification unit configured to classify the user's nose type into one of a plurality of classes within an N-dimensional variable space including the plurality of nose-related variables based on the analysis data, and a nose pad recommendation unit configured to recommend a nose pad suitable for the user's nose by referring to a representative value and nose pad adjustment value data corresponding to the classified nose type class.

In one embodiment of the personalized nose pad recommendation method, the method may include: a step of scanning a face of a user to generate a plurality of facial metric data, a step of generating analysis data including a plurality of nose-related variables describing the shape of the nose from the facial metric data, a step of classifying the user's nose type into one of a plurality of classes within an N-dimensional variable space including a plurality of nose-related variables based on the analysis data, and a step of recommending a nose pad suitable for the user's nose by referring to a representative value and nose pad adjustment value data corresponding to the classified nose type class.

According to one embodiment, key indicators related to the nasal structure may be automatically extracted simply by scanning the user’s face, thereby enabling precise analysis and recommendation without user intervention.

According to one embodiment, by quantitatively classifying the nose type within an N-dimensional variable space based on a combination of multiple nose-related variables, greater consistency and objectivity may be achieved compared to conventional subjective nose pad fitting methods.

According to one embodiment, deviations in adjustment values during actual wearing may be minimized by referring to representative values and adjustment value data for each nose type class.

According to one embodiment, a probability-based calculation may be performed for the user's input data by calculating relative distances based on a cumulative distribution function (CDF), thereby allowing even users in boundary regions to be accurately classified and optimally matched with a nose pad.

According to one embodiment, in addition to the existing plurality of nose type classes, users with outlier characteristics may be classified into a separate outlier group and provided with independent recommendations, thus enabling stable recommendations even for users with unique nasal structures.

According to one embodiment, a nose pad may be manufactured in consideration of vertex distance (VD) based on the nose pad recommendation result, and the recommendation may be validated using actual fitting data, thereby providing more reliable and effective recommendations.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram illustrating a personalized nose pad recommendation system for classifying a nose type based on facial scan data of a user and recommending a nose pad according to the classified nose type.

FIG. 2 is a diagram illustrating a principal component analysis (PCA) result of an existing variable clustering analysis.

FIG. 3 is a diagram illustrating a PCA result of a nose-related variable clustering analysis according to one embodiment.

FIG. 4 is a diagram illustrating a distribution of nasal bridge height versus nasal columella width (900).

FIG. 5 is a diagram illustrating a scoring process for calculating the probability that the nose of a specific customer belongs to a specific class.

FIG. 6, in conjunction with FIG. 5, is a diagram illustrating an embodiment that assigns, based on a cumulative distribution function (CDF) distance, a probability for each variable that the variable belongs to a specific class.

FIG. 7 is a diagram visualizing a final probability at nasal bridge height 13 and nasal columella width 23. FIG. 8 is a diagram visualizing a final probability at nasal bridge height 19 and nasal columella width 24.

FIG. 9 is a diagram illustrating a personalized nose pad recommendation method for classifying a nose type based on facial scan data of a user and recommending a nose pad according to the classified nose type.

### DETAILED DESCRIPTION OF THE DISCLOSURE

The specific structural or functional descriptions of embodiments according to the concept of the present invention disclosed herein are merely exemplary for the purpose of illustrating the embodiments, and the embodiments according to the concept of the present invention may be implemented in various forms and are not limited to the embodiments described herein.

Since various modifications and variations can be made to the embodiments according to the concept of the present invention, specific embodiments will be illustrated in the drawings and described in detail in the specification. However, this is not intended to limit the embodiments to any particular form of disclosure, and it is to be understood that the present invention includes substitutions, modifications, and equivalents falling within the spirit and scope of the invention.

The terms such as “first” or “second” may be used to describe various components, but such components should not be limited by these terms. These terms are used only to distinguish one component from another, and a “first” component may be referred to as a “second” component and vice versa without departing from the scope of the invention.

When a component is described as being "connected to" or "coupled to" another component, it should be understood that the component may be directly connected or coupled to the other component, or one or more intervening components may be present. In contrast, when a component is described as being "directly connected to" or "directly coupled to" another component, it should be understood that there are no intervening components. Expressions describing relationships between components, such as “between,” “directly between,” or “adjacent to,” should be interpreted in a similar manner.

The terminology used herein is for the purpose of describing particular embodiments only and is not intended to be limiting of the invention. As used herein, the singular forms include the plural forms as well, unless the context clearly indicates otherwise. As used herein, the terms “comprise,” “include,” or “have,” and variations thereof, are intended to specify the presence of stated features, numbers, steps, operations, elements, components, or combinations thereof, but do not preclude the presence or addition of one or more other features, numbers, steps, operations, elements, components, or combinations thereof.

Unless otherwise defined, all terms used herein, including technical and scientific terms, have the same meaning as commonly understood by one of ordinary skill in the art to which this invention belongs. Terms generally defined in commonly used dictionaries should be interpreted as having a meaning consistent with their meaning in the context of the relevant art and should not be interpreted in an idealized or overly formal sense unless expressly defined herein.

Hereinafter, embodiments will be described in detail with reference to the accompanying drawings. However, the scope of the present application is not limited to such embodiments. The same reference numerals used in the drawings refer to the same components throughout.

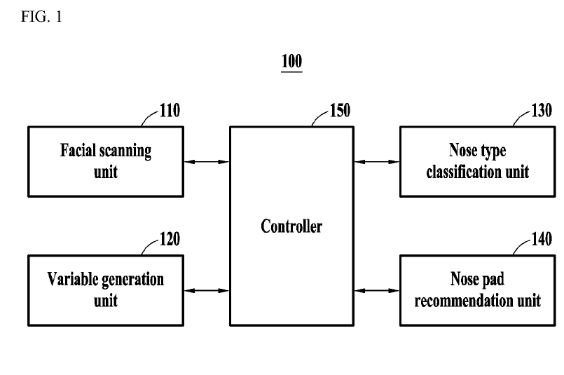

FIG. 1 is a diagram illustrating a personalized nose pad recommendation system (100) for classifying a nose type based on facial scan data of a user and recommending a nose pad according to the classified nose type.

The personalized nose pad recommendation system (100) includes:

a facial scanning unit (110) configured to scan a face of the user and generate a plurality of facial metric data;

a variable generation unit (120) configured to generate analysis data including a plurality of nose-related variables describing the shape of the nose among the facial metric data;

a nose type classification unit (130) configured to classify the user's nose type into one of a plurality of classes within a two-dimensional variable space including a plurality of variables related to the nose—such as nasal bridge height and nasal columella width—based on the analysis data; and

a nose pad recommendation unit (140) configured to recommend a nose pad suitable for the user’s nose by referring to a representative value and nose pad adjustment value data corresponding to the classified nose type class.

The facial scanning unit (110) is configured to scan the user’s face and generate a plurality of facial metric data from the scanning result. For example, the facial scanning unit (110) may capture the user’s facial shape using a smartphone Face ID function or a 3D scanner device, and extract 1,220 facial coordinate points and 18 facial metric indicators based on the captured data. The facial scanning unit (110) delivers the extracted facial metric data to the variable generation unit (120).

The variable generation unit (120) is configured to generate analysis data including a plurality of nose-related variables describing the shape of the nose based on the facial metric data received from the facial scanning unit (110). The variable generation unit (120) derives at least two or more variables among the nose-related variables from the facial metric data.

The variable generation unit (120) analyzes correlations between the derived variables and indicators that affect nose pad fitting, and removes variables that have a correlation exceeding a predetermined threshold. After this, the variable generation unit (120) generates a final analysis variable set. The variable generation unit (120) ultimately delivers the analysis data—clearly reflecting the height and width characteristics of the nose—to the nose type classification unit (130).

The nose type classification unit (130) is configured to classify the user's nose type into one of a plurality of classes within an N-dimensional variable space including a plurality of variables related to the nose, based on the analysis data received from the variable generation unit (120). The nose type classification unit (130) first removes outliers among the variables included in the analysis data and determines the number of clusters based on the elbow method and the silhouette coefficient.

The nose type classification unit (130) performs K-means clustering according to the determined number of clusters and selects variables that significantly influence nose type classification based on the clustering results. Additionally, the nose type classification unit (130) identifies user data with excessively high nose-related variable values as outliers and classifies such data into a separate outlier group, thereby constructing a total of multiple nose type classes. The nose type classification unit (130) calculates a representative value for each class by performing distance analysis based on Euclidean distance or z-score for the selected variables using user data included in each classified class.

The nose pad recommendation unit (140) is configured to recommend a nose pad suitable for the user’s nose by referring to the representative value and nose pad adjustment value data corresponding to the classified nose type class and based on the referenced information.

The nose pad recommendation unit (140) selects user data closest to the representative value for each nose type class and collects adjustment value data from those users. Based on the collected values, the nose pad recommendation unit (140) determines the recommended nose pad.

The nose pad recommendation unit (140) uses a plurality of nose-related variables as input and performs relative distance computation based on a cumulative distribution function (CDF), and calculates class-specific probability values for each variable. The nose pad recommendation unit (140) combines the calculated probability values to calculate the probability that the user’s nose type belongs to a specific class and recommends the nose pad corresponding to the class with the highest probability.

Additionally, the nose pad recommendation unit (140) sets configuration values for the plurality of nose-related variables within each nose type class such that the values do not exceed a predetermined warning value, based on adjustment value data for each nose pad type, and derives optimized reference values for each parameter to minimize deviation in the adjustment values. The nose pad recommendation unit (140) determines the nose pad that best matches the actual nose structure of the user using the optimized reference values.

Finally, the nose pad recommendation unit (140) verifies whether the recommended nose pad results in a vertex distance (VD) that falls within a standard distance range based on an actual glasses fitting test performed with real customers. If the VD value deviates from the standard distance range, the nose pad recommendation unit (140) iteratively corrects the adjustment values and updates the recommended nose pad based on the corrected values, thereby improving the precision of customized nose pad fitting for the user.

Accordingly, the personalized nose pad recommendation system (100) generates quantitative nose-related variables based on facial scanning, classifies the nose type precisely based on the variables, recommends an optimal nose pad through quantitative, statistical, and probabilistic methods according to the classified nose type, and performs verification and correction of the recommendation. Through this process, the system enables high-accuracy of personalized nose pads to users.

Among the plurality of nose-related variables, the nasal bridge height refers to the height of the nasal bridge and reflects the overall protrusion of the nose on the user’s face.

Meanwhile, the nasal columella width is defined as the horizontal distance between the inner left and right center points of the nostrils, and represents the actual width of the nasal columella.

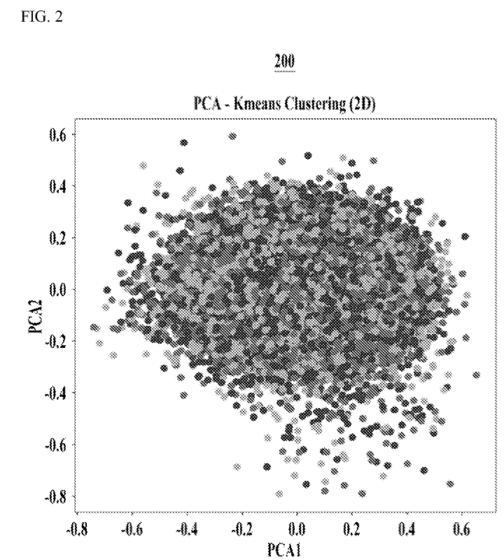

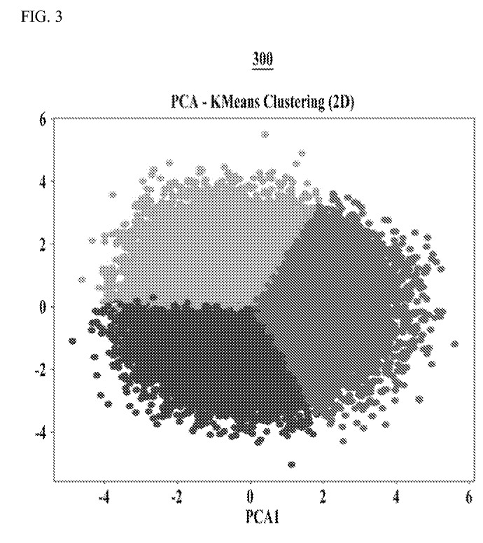

FIG. 2 is a diagram (200) illustrating the PCA (Principal Component Analysis) result of a clustering analysis based on existing variables, and FIG. 3 is a diagram (300) illustrating the PCA result of a clustering analysis based on nose-related variables according to one embodiment.

First, FIG. 2 visually represents the classification performance of nose types based on existing variables. The diagram (200) shows the result of a clustering analysis performed using a conventional set of analysis variables, projected into a two-dimensional space through principal component analysis (PCA).

Each dot shown in diagram (200) represents data for a single user. The dots are visually distinguished using different colors or markers based on the nose type classification results derived from the existing variables.

The variable generation unit (120) used a conventional variable set composed by combining only basic nose-related variables to construct the analysis data in this figure. The nose type classification unit (130) performed normalization based on the existing variables, determined the number of clusters using the elbow method and silhouette coefficient, and then classified each data point into one of multiple nose type classes based on two selected variables using K-means.

To interpret the nose type classification result visually, the nose type classification unit (130) reduced the dimensionality of the entire analysis dataset to two principal component axes (PCA1, PCA2) using PCA.

The clustering results shown in diagram (200) indicate that many data points overlap and are ambiguously distributed along class boundaries, with some clusters failing to form clearly separated boundaries. This suggests that using only the existing variables in the analysis data has limitations in effectively distinguishing structural differences among users' nose types.

Based on the analysis result, the nose type classification unit (130) identified issues such as redundancy between variables or high correlation, and concluded that an improved analysis approach was necessary. Consequently, the variable generation unit (120) was required to reconstruct the analysis data by including additional derived variables and removing highly correlated variables based on correlation analysis.

Accordingly, diagram (200) serves as a comparative illustration for emphasizing the technical advancement and distinctiveness of the present invention, by visually demonstrating the clustering limitations when using only conventional variables that do not belong to the scope of the present invention.

FIG. 3 is a diagram (300) visually illustrating the result of a nose-related variable clustering analysis according to one embodiment of the present invention, projected into a two-dimensional space through principal component analysis (PCA).

Each dot shown in diagram (300) represents data for a single user. The dots are distinguished according to the nose type class classified based on the enhanced set of analysis variables generated by the variable generation unit (120) of the present invention.

The variable generation unit (120) constructed the analysis data by deriving at least two or more nose-related variables from the user’s facial metric data. In doing so, the variable generation unit (120) analyzed the correlations between the pre-generated variables and the area- and angle-based indicators associated with the nasal columella region, which physically affect nose pad fitting. Variables with correlations exceeding a predefined threshold were removed, and a final analysis variable set was generated.

The nose type classification unit (130) performed outlier removal based on the final analysis variable set, determined the number of clusters using the elbow method and silhouette coefficient, and selected variables using K-means. Then, the classification unit classified the user’s nose type into one of a plurality of basic nose type classes based on the selected variables.

The result of the PCA confirms that the clustering performance with the newly derived variables is improved compared to the conventional approach.

This visual evidence, as contrasted with the limitations observed in FIG. 2, demonstrates that the variable configuration and clustering algorithm employed in the present invention enables more precise and stable classification of user nose types.

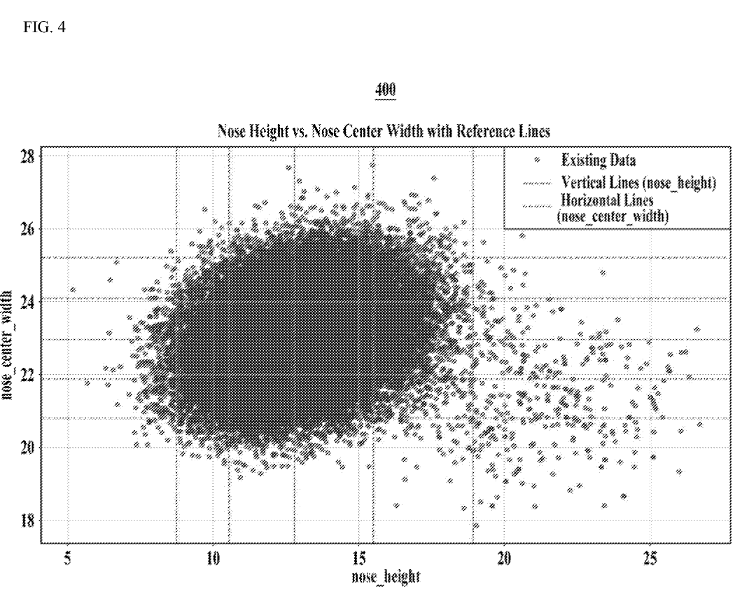

FIG. 4 is a diagram (400) visually illustrating the distribution of nasal bridge height and nasal columella width, among a plurality of nose-related variables analyzed by the nose type classification unit (130) for classifying a user’s nose type in the personalized nose pad recommendation system (100) according to the present invention.

The diagram (400) shows the distribution characteristics of overall user data by plotting the nasal bridge height value and nasal columella width value of each user as a dot on a two-dimensional variable space, with the X-axis corresponding to nasal bridge height and the Y-axis corresponding to nasal columella width, based on facial scan data obtained from a plurality of users.

The facial scanning unit (110) is configured to scan the user’s face and generate a plurality of facial metric data, which is transmitted to the variable generation unit (120).

The variable generation unit (120) derives a plurality of nose-related variables, including nasal bridge height and nasal columella width, from the facial metric data, and these variables constitute key elements of the analysis data.

The variable generation unit (120) normalizes the derived nasal bridge height and nasal columella width values using a z-score or robust z-score value, and the nose type classification unit (130) classifies user data based on the normalized values.

Each dot shown in diagram (400) represents a single user’s data, and the position of each dot is determined by the combination of that user’s nasal bridge height and nasal columella width values.

The nose type classification unit (130), based on the N-dimensional variable space, defines a vertical boundary line (indicated by a red dotted line) to set a threshold for nasal bridge height, and a horizontal boundary line (indicated by a green dotted line) to set a threshold for nasal columella width. In doing so, the entire space is divided into a grid structure.

In the digital fitting process, adjustment values such as nose pad position, nose pad angle, and nose pad shape are required to accurately placing a nose pad suitable for the user's nose. These adjustment values are stored in a configuration file.

An analysis was perfored to determine whether these adjustment values exhibit statistically meaningful differences depending on the classified nose type class. The analysis was based on a warning score, which evaluates whether each adjustment parameter is within a designable range. If the warning score exceeded a predefined threshold, the corresponding data point was regarded as an error and excluded from the analysis.

The nose type classification unit (130) calculates the density and centroid of each nose type class based on the distribution of data points within the N-dimensional variable space, and uses the calculated centroid as the representative value of each class.

The nose pad recommendation unit (140) selects user data most similar to the representative value of each class and refers to the corresponding nose pad adjustment value data to recommend a nose pad suitable for the user.

The recommended nose pad is adjusted according to individual parameters, each of which is determined based on the representative value or median value of the respective class.

Additionally, the nose pad recommendation unit (140) applies the user’s input values—nasal bridge height and nasal columella width—to a relative distance calculation based on a cumulative distribution function (CDF) to estimate the nose type class with the highest probability of correspondence and recommend the nose pad associated with that class.

As a result, FIG. 4 visually represents the quantitative characteristics of individual nose shapes, presenting the N-dimensional variable space that serves as the basis for the classification performed by the nose type classification unit (130). This space is utilized by the personalized nose pad recommendation system (100) to determine an optimal nose pad for each user.

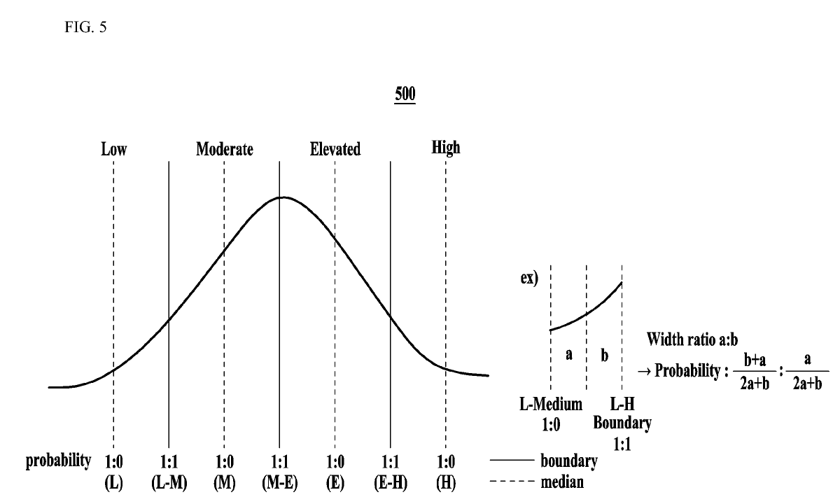

FIG. 5 is a diagram (500) illustrating a process in which the nose pad recommendation unit (140) of the personalized nose pad recommendation system (100) calculates (scores) the probability that a specific user’s nose belongs to a specific nose type class.

The diagram (500) visually presents a procedure for calculating the probability that the user’s nose-related analysis variables, received as input, belong to one of a plurality of nose type classes based on a cumulative distribution function (CDF).

The nose pad recommendation unit (140), when the user’s input value is located within the boundary range between classes, performs weighted calculation based on the cumulative probability intervals and median values of each class to quantitatively estimate the likelihood that the value belongs to one of the nose type classes.

The left graph in diagram (500) sets the X-axis as a normalized analysis variable (e.g., nasal bridge height) and the Y-axis as a relative probability or density value, and illustrates how the overall distribution is segmented into the various nose type classes.

In the graph, vertical solid lines represent the class boundaries of each nose type class, and vertical dotted lines represent the median values of each class.

If the user’s input value lies, for example, between the boundary of the ‘Low’ class and the boundary of the ‘Moderate’ class, the nose pad recommendation unit (140) calculates the probability in a continuous manner based on the relative position of the input value within that interval.

In the example shown in the figure, the user’s input value lies between the median of the Low class and the boundary of the Moderate class. The area to the left of the value is defined as a, and the area to the right as b.

Based on the area information, the nose pad recommendation unit (140) calculates the class-specific probabilities as follows:

Probability of belonging to the Low class = (b + a) / (2a + b)

Probability of belonging to the Moderate class = a / (2a + b)

This type of probability calculation corresponds to relative distance computation based on a cumulative distribution function (CDF). It has technical difference from simple threshold-based classification in that it performs continuous probability-based estimation by taking into account the relative position of the user’s input value rather than applying fixed cutoffs.

The nose pad recommendation unit (140) calculates class-specific probability values for each variable using the same method described above, and subsequently performs the same probability estimation procedure for other variables used in nose type classification.

Then, the nose pad recommendation unit (140) combines the class-specific probability values calculated for each of the classification variables to estimate the overall probability that the user’s nose belongs to one of the multiple nose type classes.

The nose pad recommendation unit (140) extracts the class with the highest probability among the estimated values—i.e., the class to which the user’s nose is most likely to belong—and refers to the nose pad adjustment value data corresponding to the identified class to recommend a nose pad suitable for the user’s nose.

To minimize deviation in probability computation, the nose pad recommendation unit (140) continuously updates the class boundary values and centroid settings for each class, and further improves the accuracy of the recommendation result by incorporating feedback from actual fitting outcomes, such as vertex distance values.

Accordingly, FIG. 5 illustrates the entire process of quantitatively calculating the probability that at least one user input variable among the nose-related analysis variables belongs to a particular nose type class, using relative distance computation based on a cumulative distribution function (CDF). The figure visually, specifically, and in detail represents the core principle of the high-precision class-based recommendation algorithm performed by the nose pad recommendation unit (140) according to the present invention.

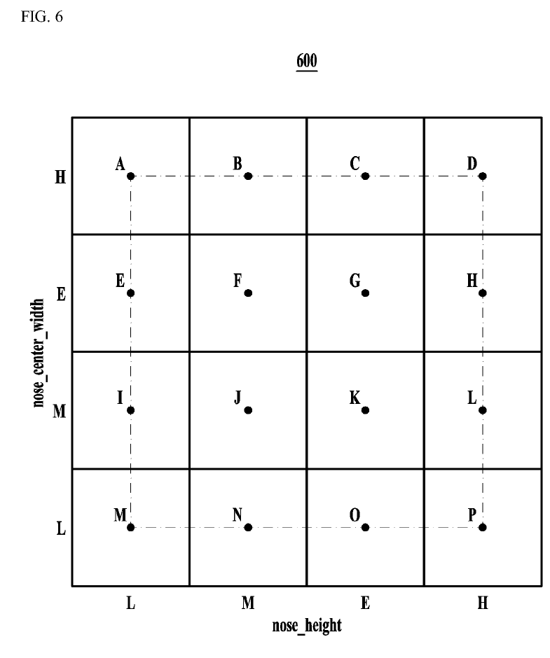

FIG. 6 is a diagram (600) illustrating an embodiment of the personalized nose pad recommendation system (100) according to the present invention, specifically showing how the nose pad recommendation unit (140) assigns class-specific probabilities for each variable based on cumulative distribution function (CDF) distance as part of a probabilistic classification technique.

In the diagram (600), a two-dimensional variable space is constructed by mapping the nasal bridge height and nasal columella width, which are derived from facial scan data received from a user, to the horizontal and vertical axes, respectively. Based on this space, the system visualizes the probability computation structure used to classify the user’s nose into one of a plurality of nose type classes.

The nose type classification unit (130) divides the normalized values of nasal bridge height and nasal columella width—obtained through z-score or robust z-score normalization—into four distinct ranges: ‘Low’, ‘Moderate’, ‘Elevated’, and ‘High’. By combining these ranges, the system defines a plurality of basic nose type classes.

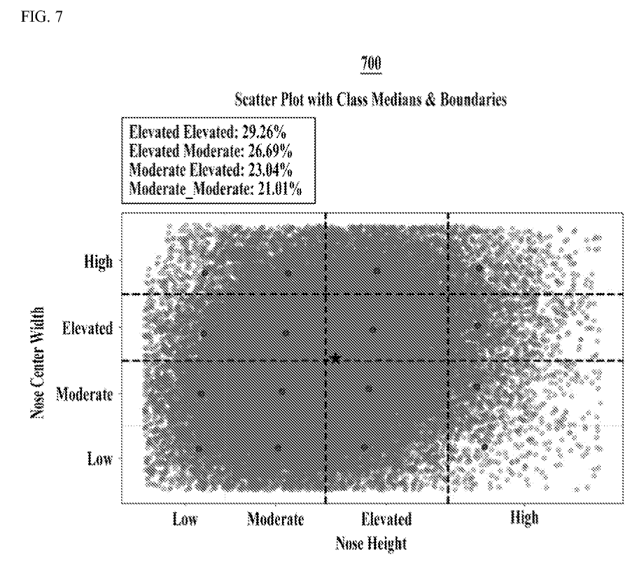

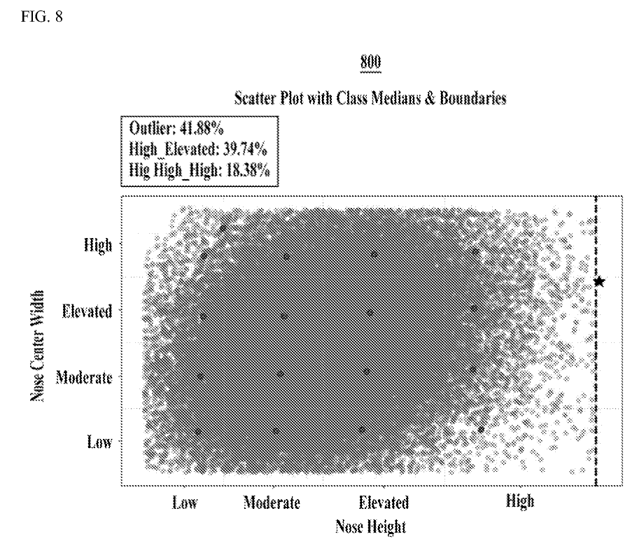

The nose type classification unit (130) partitions the two-dimensional variable space into a 4×4 grid structure, where each grid cell corresponds to a specific nose type class. For example, the bottom-left cell corresponds to the ‘Low_Low’ class, the top-right cell corresponds to the ‘High_High’ class, and the central region shown in FIG. 7 corresponds to the ‘Moderate_Moderate’ class.

FIG. 7 is a diagram (700) illustrating the final probability visualization result for a case in which the nasal bridge height is 13 and the nasal columella width is 23, within the personalized nose pad recommendation system (100) according to the present invention.

FIG. 7 visually presents the result of the nose pad recommendation unit (140) calculating, based on a cumulative distribution function (CDF)-based distance metric, the probability that a user's nose—having a nasal bridge height of 13 and a nasal columella width of 23—belongs to one of a plurality of nose type classes or to an outlier group.

The nose pad recommendation unit (140) determines the final nose type class by identifying the class with the highest probability value, which in this case is the Outlier class, and refers to the corresponding representative value and nose pad adjustment data for that class to recommend an appropriate custom nose pad to the user.

In doing so, the system ensures that the deviation in adjustment values is minimized and that each parameter setting does not exceed a predefined warning threshold, by deriving optimized reference values for each parameter.

In the diagram (700), the red star symbol indicates the position of the user data point, red solid lines represent the boundaries of each class, and blue dots denote the centroids of each class. This visual structure enables intuitive understanding of whether the user belongs to an Outlier group and how the user data is probabilistically positioned relative to surrounding nose type classes.

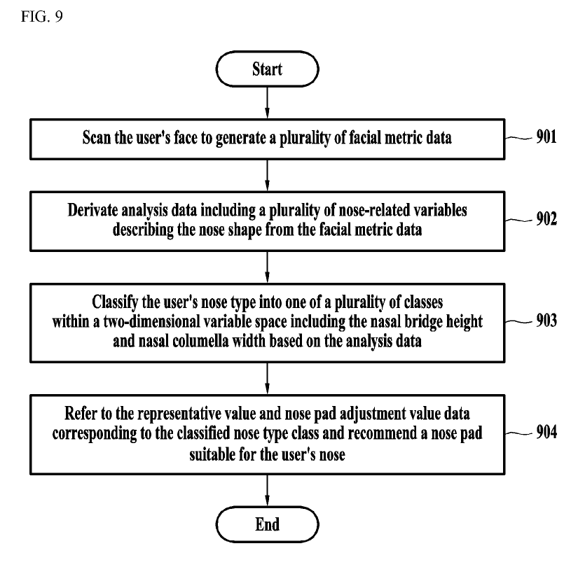

FIG. 9 is a diagram illustrating a personalized nose pad recommendation method, in which a user's nose type is classified based on facial scan data, and a nose pad is recommended according to the classified nose type.

FIG. 9 visualizes the overall execution process of the personalized nose pad recommendation method according to the present invention, comprising a series of steps for classifying a user's nose type based on facial scan data and recommending a nose pad in accordance with the classified nose type.

Each step shown in FIG. 9 directly corresponds to a component recited in the claims, and includes: a facial scanning step (901), a data derivation step (902), a nose type classification step (903), and a nose pad recommendation step (904).

The personalized nose pad recommendation method according to the present invention includes the facial scanning step (901).

In the facial scanning step (901), the facial scanning unit (110) performs a step of scanning the user’s face to generate a plurality of facial index data.

The facial scanning unit (110) uses a three-dimensional image sensor or a deep learning-based image analysis algorithm to perform a high-resolution scan of the user's full face and extract a plurality of facial index data, including various facial landmarks such as the eyes, nose, mouth, and chin.

In particular, the facial scanning unit (110) obtains precise coordinate data related to the region around the nose, such as the nasal centerline, nasal bridge height, nasal columella angle, and nasal columella width, and generates a digitized dataset that can be utilized in subsequent analysis.

The personalized nose pad recommendation method according to the present invention further includes the data derivation step (902).

In the data derivation step (902), the variable generation unit (120) performs a step of generating analysis data including a plurality of nose-related variables describing the nose shape from the facial index data.

The variable generation unit (120) derives at least two or more variables among the nose-related variables, and then analyzes correlations between these variables and indicators that physically affect nose pad fitting.

The variable generation unit (120) eliminates variables with correlation coefficients exceeding a threshold, thereby minimizing multicollinearity, and ultimately constructs a final analysis variable set optimized for nose type classification.

The personalized nose pad recommendation method according to the present invention includes the nose type classification step (903).

In the nose type classification step (903), the nose type classification unit (130) performs a step of classifying the user's nose into one of a plurality of nose type classes within an N-dimensional variable space based on the analysis data, including a plurality of nose-related variables, such as nasal bridge height and nasal columella width.

The nose type classification unit (130) additionally classifies outliers with abnormally high nasal bridge height, and establishes an Outlier group, thereby forming a total of a plurality of nose type classes.

The nose type classification unit (130) calculates a representative value for each class based on the center coordinates, and stores the result so that it can be referred to by the nose pad recommendation unit (140).

The personalized nose pad recommendation method according to the present invention includes the nose pad recommendation step (904).

In the nose pad recommendation step (904), the nose pad recommendation unit (140) performs a step of recommending a nose pad suitable for the user by referring to the representative value and nose pad adjustment data corresponding to the classified nose type class.

The nose pad recommendation unit (140) performs a relative distance calculation based on a cumulative distribution function (CDF) for each variable, using the user's input values (i.e., nasal bridge height and nasal columella width), and derives class-wise probability values for each variable based on the calculation results.

The nose pad recommendation unit (140) combines the class-wise probability values to calculate the overall probability that the user's nose belongs to a particular nose type, and selects the nose type class with the highest probability.

The nose pad recommendation unit (140) limits the configuration values so as not to exceed predefined adjustment warning thresholds and derives optimized reference values for each parameter to minimize deviations in adjustment values.

Additionally, the nose pad recommendation unit (140) verifies the appropriateness of the recommended nose pad by validating the adjustment values based on the Vertex Distance (VD) obtained from the eyewear fitting result of the user wearing the nose pad.

If the VD value does not fall within the reference distance range, the nose pad recommendation unit (140) iteratively corrects the adjustment values and updates the recommendation result accordingly.

The apparatus described above may be implemented as hardware components, software components, or a combination of hardware and software components. For example, the apparatus and components described in the embodiments may be implemented using one or more general-purpose or special-purpose computers, such as processors, controllers, arithmetic logic units (ALUs), digital signal processors (DSPs), microcomputers, field-programmable arrays (FPAs), programmable logic units (PLUs), microprocessors, or other devices capable of executing and responding to instructions. The processing device may execute an operating system (OS) and one or more software applications running on the OS. In response to executing software, the processing device may access, store, manipulate, process, and generate data. Although a single processing device is described for convenience of explanation, one of ordinary skill in the art would understand that the processing device may include multiple processing elements and/or multiple types of processing elements. For instance, the processing device may include multiple processors, or a processor and a controller, and could also include other configurations such as parallel processors.

The software may include a computer program, code, instructions, or a combination thereof, and may configure the processing device to perform a desired function or command the processing device independently or collectively. The software and/or data may be embodied permanently or temporarily in any type of machine, component, physical or virtual device, computer-readable storage medium, or signal wave to be interpreted or executed by the processing device, or to provide data or commands to the processing device. The software may also be distributed over a networked computer system and stored or executed in a distributed manner. The software and data may be stored in one or more computer-readable recording media.

The method according to an embodiment may be implemented in the form of program instructions executable by various computer means and recorded in a computer-readable medium. The computer-readable medium may include program instructions, data files, data structures, etc., individually or in combination. The program instructions recorded on the medium may be specifically designed and configured for the embodiments, or may be known and usable by those skilled in the field of computer software. Examples of computer-readable recording media include magnetic media such as hard disks, floppy disks, and magnetic tapes; optical media such as CD-ROMs and DVDs; magneto-optical media such as floptical disks; and hardware devices such as ROM, RAM, and flash memory configured to store and execute program instructions. The program instructions include not only machine code generated by a compiler, but also high-level language code executable by a computer using an interpreter or the like. The above-described hardware components may be configured to operate as one or more software modules to perform the operations of the embodiments, and vice versa.

While the embodiments have been described with reference to limited drawings, various modifications and alterations may be made by those skilled in the art based on the above description. For example, the described techniques may be performed in a different order than described, and/or the systems, structures, devices, circuits, and components described may be combined or configured differently, or replaced or substituted with other components or equivalents, while still achieving desirable results.

Accordingly, various implementations, embodiments, and equivalents thereof also fall within the scope of the following claims.

What is claimed is:

1. A personalized nose pad recommendation system for classifying a nose type based on facial scan data of a user and recommending a nose pad according to the classified nose type, the system comprising:
a facial scanning unit configured to scan a face of the user and generate a plurality of facial metric data;
a variable generation unit configured to generate analysis data including a plurality of nose-related variables describing a shape of the nose among the facial metric data;
a nose type classification unit configured to classify the nose type of the user into one of a plurality of classes within an N-dimensional variable space including the plurality of nose-related variables based on the analysis data; and
a nose pad recommendation unit configured to recommend a nose pad suitable for the user’s nose by referring to a representative value and nose pad adjustment value data corresponding to the classified nose type class.

2. The personalized nose pad recommendation system of claim 1,
wherein the variable generation unit is configured to analyze correlations between pre-generated variables and area- and angle-based indicators associated with a nasal columella region that physically affects nose pad fitting, remove variables with correlations higher than a predetermined threshold, and generate a final analysis variable set.

3. The personalized nose pad recommendation system of claim 1,
wherein the nose type classification unit is configured to remove outliers based on the final analysis variables, determine a number of clusters based on an elbow method and silhouette coefficient, select variables using K-means, and classify the nose type into a plurality of basic nose type classes based on the two types of variables.

4. The personalized nose pad recommendation system of claim 1,
wherein the nose pad recommendation unit is configured to determine a recommended nose pad by selecting user data most similar to the representative value for each nose type class, calculating adjustment values based on nose pad adjustment value data, and using the calculated values.

5. The personalized nose pad recommendation system of claim 1,
wherein the nose pad recommendation unit is configured to derive optimized reference values for each parameter such that, based on adjustment value data for each type of nose pad, setting values for position, angle, and shape of the nose pad within each nose type class do not exceed a predefined adjustment warning value and deviation in adjustment values is minimized.

6. The personalized nose pad recommendation system of claim 1,
wherein the nose pad recommendation unit is configured to verify the recommended nose pad corresponding to the user’s classified nose type using a vertex distance (VD) value obtained from an actual glasses fitting test of real customers, and to iteratively adjust the adjustment values such that the VD value falls within a reference distance range, thereby correcting the recommendation result.

7. A personalized nose pad recommendation method for classifying a nose type based on facial scan data of a user and recommending a nose pad according to the classified nose type, the method comprising:
scanning the user’s face to generate a plurality of facial metric data;
derivating analysis data including a plurality of nose-related variables describing the nose shape from the facial metric data;
classifying the nose type of the user into one of a plurality of classes within a two-dimensional variable space including a plurality of nose-related variables based on the analysis data; and
recommending a nose pad suitable for the user’s nose by referring to a representative value and nose pad adjustment value data corresponding to the classified nose type class.

8. The personalized nose pad recommendation method of claim 7,
wherein the derivating of the analysis data comprises analyzing correlations between the pre-generated variables and indicators that physically affect nose pad fitting, removing variables with correlations exceeding a predetermined threshold, and generating a final analysis variable set.

9. The personalized nose pad recommendation method of claim 7,
wherein the classifying of the nose type comprises removing outliers based on the final analysis variables, determining a number of clusters based on an elbow method and silhouette coefficient, selecting variables using K-means, and classifying the nose type into a plurality of basic nose type classes based on the selected variables.
